(19) United States
(12) Patent Application Publication
(10) Pub. No.: US 2009/0144133 A1
(43) Pub. Date: Jun. 4, 2009

(54) CONTEXT RELATED ADVERTISEMENT/INFORMATION EXPOSURE METHOD AND RECOMMENDATION SERVICE SYSTEM USING THE SAME

(75) Inventors: Young-Chul Cha, Seoul (KR); Seong-Hwan Jang, Seoul (KR)

Correspondence Address: LEXYOUME IP GROUP, LLC, 5180 PARKSTONE DRIVE, SUITE 175, CHANTILLY, VA, 20151, US

(73) Assignee: KT Corporation, Seongnamj-city (KR)

(21) Appl. No.: 12/301,046

(22) PCT Filed: May 16, 2007
(86) PCT No.: PCT/KR2007/002394

§ 371 Date: Nov. 17, 2008

(30) Foreign Application Priority Data
May 16, 2006 (KR) 10-2006-0043850
May 14, 2007 (KR) 10-2007-0046577

(51) Int. Cl. G06Q 30/00; G06Q 20/00

(52) U.S. Cl. 705/10; 705/14

(57) ABSTRACT

Provided are a context related advertisement/information exposure method and a recommendation service system. The method includes the steps of: queuing information recommended (‘recommended information’) by a user on a queue list; selecting a candidate group (current list) to be exposed in an information region of contents page; determining an initial exposure number of each recommended information on the current list, and mapping each recommended information on the current list by the initial exposure number upon exposure of the contents to expose the same; comparing each recommended information that has been exposed by the exposure number with a reference value to determine whether its remaining on the current list is required; and determining a unit exposure number of recommended information that remains on the current list (residual recommended information), and mapping the residual recommended information by the unit exposure number upon exposure of the contents, to thereby expose the same.

### TECHNICAL FIELD

The present invention relates to an advertisement/information exposure method capable of enhancing advertisement efficiency through improvement of mapping hit-ratio of context advertisement and a context advertisement/information recommendation service system using the same, and a computer-readable storage medium that stores a software program for implementing the method.

### BACKGROUND ART

The Internet advertisement market starting from a banner advertisement is evolving into a context advertisement beyond a keyword advertisement. The ‘context advertisement’ is a method that provides contents on the Internet in link with an advertisement with high relation therewith in a manner that an advertisement related to an article on a newspaper is arranged to be carried on the same paper as the article, to cause users to click the advertisement.

However, since the conventional context advertisement performs a mapping of contents and advertisement in a mechanical way, there may be often a mapping of an advertisement that is not related to the contents. In one example, the context advertisement that is under the lead of Google's AdSense simply conducts a mapping of contents and advertisement in a mechanical way and thus does not show a satisfactory mapping hit-ratio. That is, since the context advertisement made by a Google's context analysis algorithm simply finds a keyword related to a context and maps a keyword advertisement thereto, there may be sometimes a mapping of a context advertisement (for example, mapping of a camera/computer advertisement to a portable phone related article) that is not related with the contents at all.

In particular, in the context advertisement by the Google's context analysis algorithm, its hit-ratio is more unreliable if the contents are made in Korean not English. Further, in case of mechanical mapping, since an enterpriser with high relation data between keywords like Google has a high competitiveness, a late enterpriser becomes more difficult to enter the context advertising market. In addition, the existing advertisement displays only advertisement words that were previously registered by an advertiser, which does not lead an Internet user into temptation to click the advertisement.

Therefore, there is an urgent need for a scheme capable of improving a mapping hit-ratio of context advertisement and providing an interesting advertisement in the technical field of the current Internet advertisement, and allowing late enterprisers to easily enter this context advertising market.

### DISCLOSURE

### Technical Problem

It is, therefore, an object of the present invention to provide an advertisement/information exposure method which is capable of enhancing a mapping hit-ratio of context advertisement during an Internet advertisement and allowing late enterprisers to easily enter a context advertising market and a context advertisement/information recommendation service system using the same, and a computer-readable storage medium that stores a software program for implementing the method.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an exposure method of Internet information for improvement of mapping hit-ratio of context information, the method including the steps of: queuing information recommended (‘recommended information’) by a user who coincides with details of contents on a queue list; selecting a candidate group (current list) to be exposed in an information region of contents page out of the recommended information on the queue list; determining an initial exposure number of each recommended information on the current list, and mapping each recommended information on the current list by the initial exposure number upon exposure of the contents to expose the same; comparing each recommended information that has been exposed by the exposure number with a reference value to determine whether its remaining on the current list is required; and determining a unit exposure number of recommended information that remains on the current list (residual recommended information), and mapping the residual recommended information by the unit exposure number upon exposure of the contents, to thereby expose the same.

Also, the method further includes the steps of: comparing residual recommended information that has been exposed by the unit exposure number with the reference value to determine whether its remaining on the current list is required; and determining a unit exposure number of residual recommended information that again remains on the current list (re-residual recommended information), and mapping the re-residual recommended information by the unit exposure number upon exposure of the contents, to thereby expose the same.

Also, the method further includes the step of allowing one of recommended information above the reference value, the residual recommended information and the re-residual recommended information to remain on the current list.

Also, the method further includes the step of queuing one of recommended information below the reference value, the residual recommended information and the re-residual recommended information on a disuse list.

Also, the method further includes the step of reentering one of advertisement recommended by an advertiser, the residual recommended advertisement and the re-residual recommended advertisement, among advertisements queued on the disuse list, into the queue list.

In accordance with another aspect of the present invention, there is provided a context advertisement recommendation service system for improvement of mapping hit-ratio of context advertisement through linkage between a contents site and an advertiser site, the system including: an advertisement registration means for supporting that advertisements are to be registered; an advertisement recommendation means for providing an advertisement related to a user input keyword for the user (recommender) to recommend an advertisement that coincides with details of contents; an advertisement list providing means for managing the advertisement recommended by the user (‘recommended advertisement’) by contents, and mapping the recommended advertisement by an initial exposure number and a unit exposure number upon exposure of the contents to expose the same; and a mapping evaluation means for supporting that an evaluator can evaluate the mapping result of the exposed contents and the recommended advertisement.

In accordance with another aspect of the present invention, there is provided a context information recommendation service system for improvement of mapping hit-ratio of context information, the system including: a link information recommendation means for allowing a user (recommender) to recommend link information that coincides with details of contents; a link information list providing means for managing the link information recommended by the user (‘recommended link information’) by contents, and mapping the recommended link information by an initial exposure number and a unit exposure number upon exposure of the contents to expose the same; and a mapping evaluation means for supporting that an evaluator can evaluate the mapping result of the exposed contents and the recommended link information.

In accordance with another aspect of the present invention, there is provided a computer-readable recording medium for storing a program implementing a method for improving mapping hit-ratio of context information in an information exposure system with a processor, the method including the steps of: queuing information recommended (‘recommended information’) by a user, which coincides with details of contents, on a queue list; selecting a candidate group (current list) to be exposed in an information region of contents page out of recommended information on the queue list; determining an initial exposure number of each recommended information on the current list, and mapping each recommended information on the current list by the initial exposure number upon exposure of the contents to expose the same; comparing each recommended information that has been exposed by the initial exposure number with a reference value to determine whether its remaining on the current list is required; and determining a unit exposure number of the recommended information that remains on the current list (residual recommended information), and mapping the residual recommended information by the unit exposure number upon exposure of the contents to thereby expose the same.

Also, the computer-readable recording medium further includes the steps of: comparing residual recommended information that has been exposed by the unit exposure number with the reference value to determine whether its remaining on the current list is required; and determining a unit exposure number of residual recommended information that again remains on the current list (re-residual recommended information), and mapping the re-residual recommended information by the unit exposure number upon exposure of the contents, to thereby expose the same.

Also, the computer-readable recording medium further includes the step of allowing one of recommended information above the reference value, the residual recommended information and the re-residual recommended information to remain on the current list.

Also, the computer-readable recording medium further includes the step of queuing one of recommended information below the reference value, the residual recommended information and the re-residual recommended information on a disuse list.

The present invention is to enhance advertisement efficiency by improving a mapping hit-ratio of context advertisement that is fast-growing, especially in the field of the Internet advertisement.

To this end, the present invention improves a mapping hit-ratio of context advertisement by applying collective intelligence through participation of Internet users, in stead of mapping of contents and advertisement (where its representative example is Google's AdSense), which has been simply conducted in a mechanical way at present.

In other words, the present invention improves a mapping hit-ratio of context advertisement and allows late enterprisers to easily enter this market by mapping a recommended advertisement that coincides with details of contents by Internet users, rather than the simple mechanical mapping.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### ADVANTAGEOUS EFFECTS

As mentioned above and will be discussed below, the present invention improves a hit-ratio of context advertisement provides an interesting advertisement to enable an efficient advertisement in an advertiser's position and offer, in a contents owner's position, an advertisement more related to the owner own contents, which expects a more benefit. Furthermore, the advertisement recommender can also obtain a monetary benefit by the advertisement recommendation and a late context advertisement enterpriser can effectively enter an adverting market without holding a competitive search engine. Moreover, more effective advertisement effect can be created by implementing mapping with high connection of contents and advertisement through cooperation with the existing context advertisement enterpriser.

### BRIEF DESCRIPTION OF THE DRAWINGS

FIG. 1 is a view showing the structure of a context advertisement recommendation service system for improvement of mapping hit-ratio of context advertisement in accordance with a preferred embodiment of the present invention.

FIG. 2 is a view illustrating an advertisement recommendation screen of the context advertisement recommendation system in accordance with the present invention.

FIG. 3 is a view illustrating an overall advertisement list screen of the context advertisement recommendation system in accordance with the present invention.

FIG. 4 is a view illustrating a mapping evaluation screen of the context advertisement recommendation system in accordance with the present invention.

FIG. 5 is a flowchart illustrating an advertisement exposure method for improvement of mapping hit-ratio of context advertisement in accordance with another preferred embodiment of the present invention.

FIGS. 6 and 7 are explanatory views showing a modified example and a linking procedure of the context advertisement recommendation system in accordance with the present invention.

### BEST MODE FOR THE INVENTION

The advantages, features and aspects of the invention will become apparent from the following description of the embodiments with reference to the accompanying drawings, which is set forth hereinafter. Thus, the present invention will be easily carried out by those skilled in the art. Further, in the following description, well-known arts will not be described in detail if it seems that they could obscure the invention in unnecessary detail. Hereinafter, preferred embodiments of the present invention will be set forth in detail with reference to the accompanying drawings.

The present invention can be divided into an ‘AdHelper system (context advertisement recommendation service system)’ that offers advertisements related to contents and a ‘SurfHelper system (context information recommendation service system)’ that provides link information related to contents. The ‘AdHelper system’ and the ‘SurfHelper system’ are similar to each other in structure, and therefore, the AdHelper system will be described below.

For convenience, the context advertisement recommendation service system for improvement of mapping hit-ratio of context advertisement of the present invention is named as the ‘AdHelper system’ and the service offered by the AdHelper system as an ‘AdHelper service’. But, if their clear division is not needed, they are commonly called ‘AdHelper’.

First, the participants of the AdHelper service are divided into an ‘advertiser’, a ‘contents owner’, and an ‘Internet user’.

Here, the ‘advertiser’ denotes a person or enterprise that wishes to offer context advertisement through the AdHelper system, and the ‘contents owner’ indicates a person or enterprise that has the ownership of contents. And, the ‘Internet user’ refers to a general netizen who uses the Internet.

The ‘Internet user’ can be divided, based on the purpose of participation, into three: a ‘recommender’ who maps contents and advertisement, an ‘evaluator’ who evaluates mapping of the contents and advertisement, and a ‘consumer’ who consumes the contents and advertisement only. At this time, the recommender, the evaluator and the consumer are not divided individually but by role. Thus, the recommender may be the evaluator and consumer at the same time, and vice versa.

In case of contents (UCC: User Created Contents) manufactured by a general user, the contents' owner may be recommender and/or evaluator at the same time. That is, the user can register contents (UCC) on a UCC service site and at the same time recommend an advertisement for their mapping. Therefore, the present invention can select an advertisement when putting a moving image at a UCC moving image portal and attach it thereto, and distribute a profit created thereby to the contents register.

While the existing context advertisement model is constituted by the advertiser, the contents owner and the consumer, the advertisement model by the AdHelper system of the present invention adds thereto a ‘recommender’ who offers effective mapping of contents and advertisement and an ‘evaluator’ who verifies the appropriateness of such mapping, thereby providing the recommender and the evaluator with a monetary or honorable profit. In addition, the consumer, the evaluator and the recommender are all Internet users and divided not individually but by role. Therefore, they can conduct more than two roles at the same time, which reflect the property of web 2.0 such as prosumer and collective intelligence.

The AdHelper system provides the functions that allow an advertiser to effectively register advertisements (advertisement registration function), a recommender to recommend advertisement that coincides with details of contents and map them (advertisement recommendation function), evaluate the mapped advertisement to evaluate the reliability of advertisement and in turn recommender (mapping evaluation function), and a consumer to show an advertisement list (overall advertisement list function) at a glance. For this, it provides each service page.

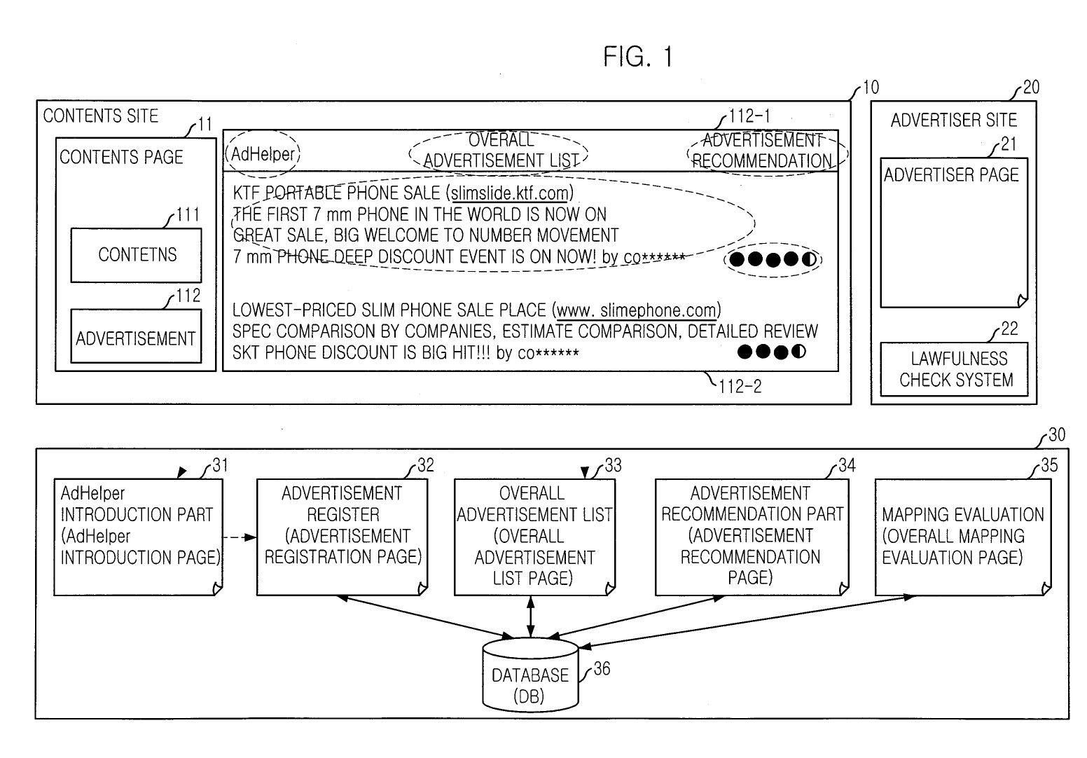

Hereinafter, the context advertisement recommendation service system (AdHelper system) for mapping hit-ratio of context advertisement in accordance with the invention will be described in more detail with reference to FIG. 1. In the following description, an ‘AdHelper site’ is referred to as the ‘AdHelper system’.

In FIG. 1, there are provided a contents site 10, an advertiser site 20, an AdHelper site (context advertisement recommendation service system) 30 and service pages 11, 21, and 31 to 35 provided by each of the sites 10 to 30, and a relationship therebetween.

Specifically, the context advertisement recommendation service system (AdHelper site) 30 that recommends context advertisement in link with the contents site 10 and the advertiser site 20 includes an advertisement registration part (advertisement registration page) 32 for supporting that an advertiser can register advertisements, an advertisement recommendation part (advertisement recommendation page) 34 for providing an advertisement related to a user input keyword for a user (recommender) to recommend an advertisement that coincides with details of contents, an overall advertisement list part (overall advertisement list page) 33 for managing the advertisement recommended by the user (recommended advertisement) by contents, and mapping the recommended advertisement (which is a context advertisement by contents selected by the user (recommender) when it is determined to be coincided with the details of contents, wherein an exposure number is determined depending on an exposure rate of the contents and exposed in a WRR (Weighted Round Robin) manner upon exposure of the contents, and contents with large exposure have a large number of candidate groups of advertisements and contents with small exposure have a small number of candidate groups of advertisements) by an initial exposure number (which is determined by the exposure rate of the contents and the reliability of recommender) and a unit exposure number (which is determined by the exposure rate of the contents, a click rate, mapping reliability and advertisement rates) to expose the same (wherein upon exposure of the recommended advertisement, the reliability of recommender who recommended the advertisement and mapping reliability of the contents and the recommended advertisement are shown together, and the reliability of recommender is represented by an accumulation value of the mapping reliability) upon exposure of the contents, and a mapping evaluation part (mapping evaluation page) 35 for supporting that an evaluator can evaluate the mapping result of the exposed contents and the recommended advertisement.

First, the contents site 10 is a site such as a general portal, a newspaper company or the like that offers various contents, and also corresponds to a site that offers useful contents such as a company's homepage or community group. Further, it may include blog and mini homepage that are personally managed as well as café that is managed by groups.

Further, the type of contents provided by the contents site 10 is not limited to the text but includes various types such as image, moving image, voice, game, flash, etc., and may take a combined type of more than two types.

A contents page 11 of the contents site 10 basically contains contents 111 that are connected to an advertisement 112. At this time, the contents page 11 may not be a web/wap page, but may be provided over TV or radio, and an advertisement linked therewith may not also be in the form of text only. That is, a moving image advertisement, a voice advertisement, a character advertisement and so on are possible, even in case of being provided in the web/wap page. In addition, it may contain a moving image advertisement provided before watching TV, a character/voice advertisement provided through a speaker or caption during TV broadcasting, a voice advertisement provided before radio broadcasting, and the like.

Here, since a moving image is composed of several frames, an advertisement can be mapped by frame groups. Thus, several advertisements can be exposed alternately while the moving image is played.

More details of the advertisement region 112 being embedded in the contents page 11 will be given below, wherein a menu region 112-1 is arranged at an upper end thereof.

There are basically registered three menus of an ‘AdHelper’, an ‘overall advertisement list’, and an ‘advertisement recommendation’ in the menu region 112-1. When a user clicks the ‘AdHelper’, it is moved to an introduction page (AdHelper introduction part) 31 for AdHelper service. At this time, the AdHelper introduction page 31 provides link information for connection back to the advertisement registration page 32 for advertiser.

Further, when the user clicks the ‘overall advertisement list’, it is moved to the overall advertisement list page 33, wherein an advertisement currently mapped with the contents 111 is arranged and displayed depending on various bases.

Additionally, when the user clicks the ‘advertisement recommendation’, it is coupled to the advertisement recommendation page 34 so that the recommender can recommend an advertisement associated with the contents 111.

Meanwhile, a body region 112-2 below the menu region 112-1 is a region where an advertisement is shown directly. Here, the type of advertisement shown in the body region 112-2 may be various types such as text as well as image, moving image, flash, etc.

The components of advertisement are given based on the text as follows. There are a subject of advertisement that is previously registered by an advertiser, an advertiser site's address, a description for advertisement, and comments to be registered by a recommender. Further, there may be further displayed a recommender ID through partial disclosure or full disclosure, or anonymously, along with an evaluator's mapping evaluation or a recommender's evaluation to exhibit the reliability of advertisement.

Further, the number of advertisements shown in the body region 112-2 is determined by a contents owner, and a profit distribution rate when clicking an advertisement by a consumer is basically determined by the AdHelper site 30 but may be varied by the contents owner.

At this time, the number of advertisements is normally proper to be set less than 5 but may be determined to be a fixed number every the contents site 10. Preferably, the number of advertisements may be flexible depending on the exposure rate of the contents page 11. That is, the contents page 11 with great exposure is exposed along with a great number of advertisements, and the contents page 11 with small exposure is exposed along with a small number of advertisements.

The profit distribution is made in a manner that an amount of money determined per specific action such as click, exposure, or consumer's purchase, joining and the like is distributed to a contents owner, the AdHelper site 30 and a recommender. Here, the contents owner indicates a medium (media) that is generally referred to in the advertisement field. If the user (contents owner) registers contents in a medium like an Internet community site or UCC site, the medium takes a distributed amount of money and can distribute it to the contents register. Further, for the amount of money distributed to the recommender, a higher distribution rate may be applied if the mapping reliability of advertisement is high and a lower distribution rate if it is low. In addition, the profit may also be distributed to the consumer according to cases, and, in this case, plug-in, tool bar, etc. are installed in the web browser of the consumer to receive a consumer's favorable field or analyze a consumer's web use pattern. By doing so, among advertisements recommended during the context advertisement, an advertisement that is expected that the consumer's favorability will be high may be arranged first. Further, a fixed amount of money or point per evaluation may be provided to an evaluator, along with honorable compensation, thereby effectively inducing a motive. For example, it is possible to select an evaluator who normally evaluated several times an advertisement related to a specific keyword at regular periods and put the same in a hall of honor and so on. Besides, a part of profit may be provided as a donation if the contents owner wishes to do so. In this case, an icon may be marked in the menu region 112-1 of the advertisement region 112 and a color of an outer line of advertisement may be set to be different from others, thereby indicating that the donation was made.

When the consumer clicks one of a subject (a subject of advertisement), an address (an advertiser site's address), a description (a description on advertisement), comments (comments registered by recommender) in the body region 112-2, it is moved to the advertiser site 20 to create advertisement effect. At this time, a consumer ID (when logging-in), an IP address, a click time, URL of contents, and so on remain in the contents site 10 as log, and at the same time log information is delivered to the AdHelper 30 and the advertiser site 20 to be used in searching an unfair click later.

Meanwhile, the advertiser site 20 has an advertiser page 21 storing details of advertisement, and installs a lawfulness check system 22 therein so that a stay and movement, action and so on in the advertiser site 20 according to the consumer ID and IP remain as log to analyze a pattern in order to check whether it is a lawful click. This lawfulness check system 22 sends the consumer's log information and pattern information to the AdHelper site 30 to be used to prevent an unfair click dispute that may occur later.

In case the advertisement 112 associated with the contents 111 does not exist in the database 36 of the AdHelper site 30, an advertisement proposal may be sent to a person who is in charge of advertisement of a corresponding enterprise by using a mail, etc., and the AdHelper site 30 can support an advertisement proposer to effectively prepare this advertisement proposal. In this case, if the person in charge of advertisement accepts it, the advertisement proposer can receive a certain service charge.

The AdHelper site 30 may be provided by itself, and also in link with the context advertisement such as the AdSense and so on.

The latter method is a method that performs additional recommendation, when Internet users watch the corresponding contents page and feel that there is an advertisement with a lower mapping hit-ratio or higher mapping hit-ratio after offering the context advertisement mechanized like AdSense in link with contents. In this case, of course, the advertisement profit created by click is distributed between the contents owner and the AdHelper site 30 in case of the mechanized context advertisement, and the profit by click of the recommended advertisement is also shared with the recommender.

Main pages in the AdHelper site 30 include the AdHelper introduction page (AdHelper introduction part) 31, the advertisement registration page (advertisement registration part) 32, the overall advertisement list page (overall advertisement list part) 33, the advertisement recommendation page (advertisement recommendation part) 34, the mapping evaluation page (mapping evaluation part) 35, etc. These pages 31 to 35 are coupled with the database 36 inside the AdHelper site 30.

The AdHelper introduction page 31 contains the general introduction contents on the AdHelper service and also has link information to the advertisement registration page 32, so it is moved to the advertisement registration page 32 through a click of an advertiser who wants advertisement.

The advertisement registration page 32 is a page where the advertiser does advertisement registration, and may register advertisements on the basis of a keyword, as in the advertisement registration of the existing context advertisement. In particular, a unit cost of advertisement that is not limited to the keyword can also be applied thereto. This is because the existing context advertisement is a method that decides the priority of exposure depending on the unit cost of an advertisement that purchases a corresponding keyword after mechanically extracting the keyword from the contents and thus has a high dependency on the keyword, while the AdHelper site 30 has a relatively low dependency on the keyword since it is not uniform as being extracted by the recommender.

The advertiser may select a charging method such as CPM (Cost Per Milli), CPC (Cost Per Click), or CPA (Cost Per Action (an advertisement consumer's specific action such as consumer's purchase, joining, etc.)), and may provide a service in link with a shopping mall and the like in case of doing charging per purchase of advertisement consumer. At this time, in case of linking with the shopping mall, the existing shopping mall operator or seller becomes an advertiser. This way is the most reasonable charging way in the advertiser's position since he or she provides a portion of selling price to AdHelper only when a sale happens. In the AdHelper's position, it is advantageous that the difficult in securing the advertiser at an initial stage can be solved simply by cooperating with the shopping mall. This action-based charging is not limited to only the purchase but may be extended to various actions determined by the advertiser as well as member joining. Here, in order to know whether any action occurs actually, there is generally used a method which tracks an action of advertisement consumer by cooperation with the advertiser site.

The contents owner can also be registered in the AdHelper system. In this case, when the contents owner inputs a name, a resident registration number, a contact address, URL, etc. to the AdHelper system, the AdHelper service provider examines its lawfulness and sends an advertisement code to the contents owner by using an email, etc. if lawful. The contents owner inserts the advertisement code into a desired webpage, thereby receiving the advertisement from the AdHelper system.

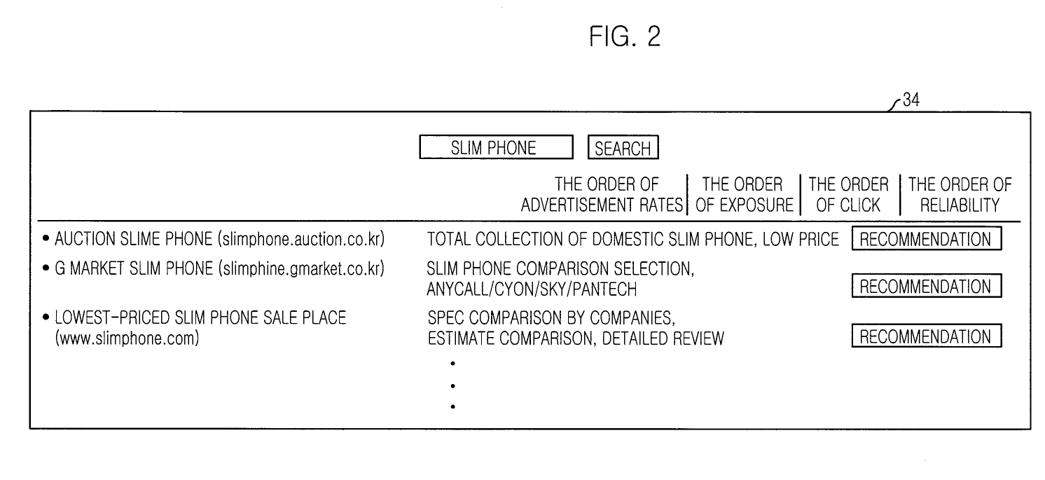

The advertisement recommendation page 34 is a page where the recommender uses for advertisement recommendation. When the recommender inputs a keyword and tries to search as shown in FIG. 2, it sorts an advertisement associated with the corresponding keyword and then sends the same to the recommender. At this time, sorting is basically made by advertising costs per click, but may be made by various bases such as a click number, an exposure number, mapping reliability, etc. The recommender inputs comments upon recommendation, wherein the comments are copy writing for advertisement and are for more interesting thereof, thereby improving attention of the advertisement.

In FIG. 2, when the recommender recommends a specific advertisement out of advertisements resulted from the keyword search, it is revealed that there exists a relationship between the recommended advertisement and the search keyword, and this data is stored as log and can be used for analysis and improvement of the advertisement later. Further, the search keyword may be tag information on contents, which may be utilized as meta data of the contents later. At this time, the recommender can recommend only one advertisement or advertisements less than a preset number per the contents 111 in order to prevent an exclusive action of one recommender.

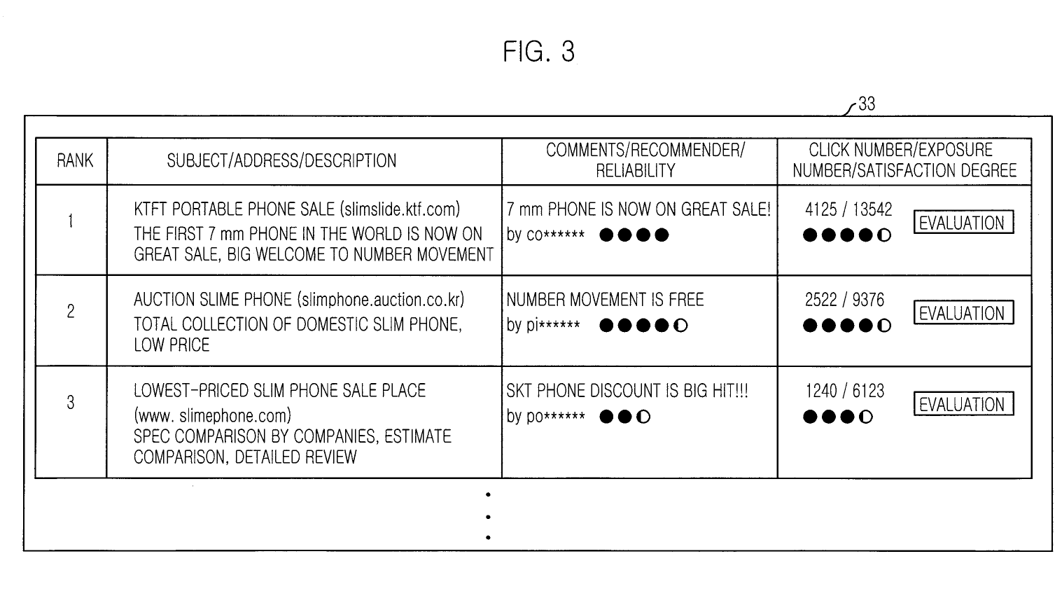

The overall advertisement list page 33 indicates a list of overall candidate groups of advertisements that are mapped with the corresponding contents 111 by rankings, as shown in FIG. 3. At this time, the number of advertisements in the overall advertisement list relies upon the exposure rate of the corresponding contents 111. That is, since the high exposure rate of the contents 111 means that the exposure number of times is large by the exposure rate, several advertisements are managed as a candidate group, and mapped and displayed by the advertisement number that can be displayed on one screen with one contents 111 in a WRR way.

FIG. 3 shows a structure of the overall advertisement list page 33 wherein reliability is shown in two kinds. In FIG. 3, the reliability in the medium represents that of the recommender and the right reliability denotes the reliability of mapping of the contents 111 and the advertisement 112. Here, the reliability of recommender is represented by an accumulation value of the mapping reliability and an initial value of the mapping reliability is calculated from the reliability of recommender. Therefore, an initial exposure number of advertisement recommended by the recommender is determined by the reliability of recommender, so that the recommender reliably can recommend the advertisement.

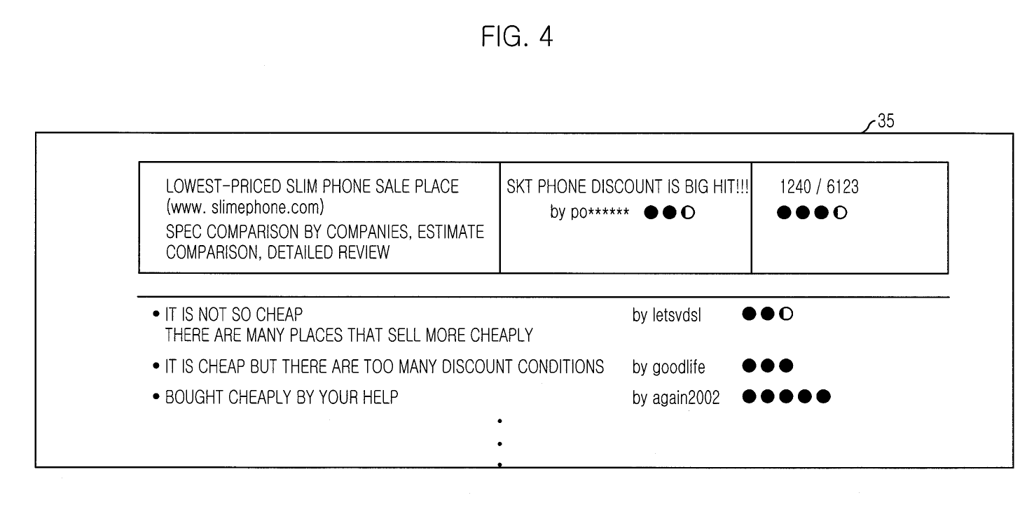

The mapping evaluation page 35 is a page that evaluates mapping of the contents 111 and the advertisement 112 as shown in FIG. 4, and may be configured in a separate page and in the form of a pop-up window. At this time, the evaluator requires log-in for evaluation, and his or her ID is required to be fully disclosed to make the evaluation thoughtlessly done, unlike the recommender ID that requires no disclosure or a partial disclosure. In addition, it may be possible to continuously manage the evaluation record of the evaluator and select a person who has a small difference between the evaluation point of the evaluator and an average evaluation point (mapping reliability) of the corresponding advertisement at regular periods, thereby giving honorable compensation like a ‘master of evaluation’ or point compensation. The mapping evaluation is a procedure of increasing or decreasing the mapping reliability within a constant range. Besides the mapping evaluation, the mapping reliability can be increased by the click or exposure of advertisement little by little.

In summary, when the recommender recommends an advertisement through the advertising recommendation page 34, the recommended advertisement is queued on a queue list of the overall advertising list page 33 and the list of recommended advertisement being queued on the current list is indicated by rankings in the overall advertisement list page 33 upon exposure of the contents. Here, the recommended advertisement is queued on the queue list in a FIFO (First-In First-out) manner by recommendation of the recommender, prior to entering the current list. The current list is an advertisement list that is represented when clicking the overall advertisement list as candidate groups to be exposed in the advertisement region 112 of the contents page 11.

Thereafter, the evaluator evaluates the mapping result of recommended advertisements being exposed on the contents through the mapping evaluation page 35, which is reflected for every recommended advertisement.

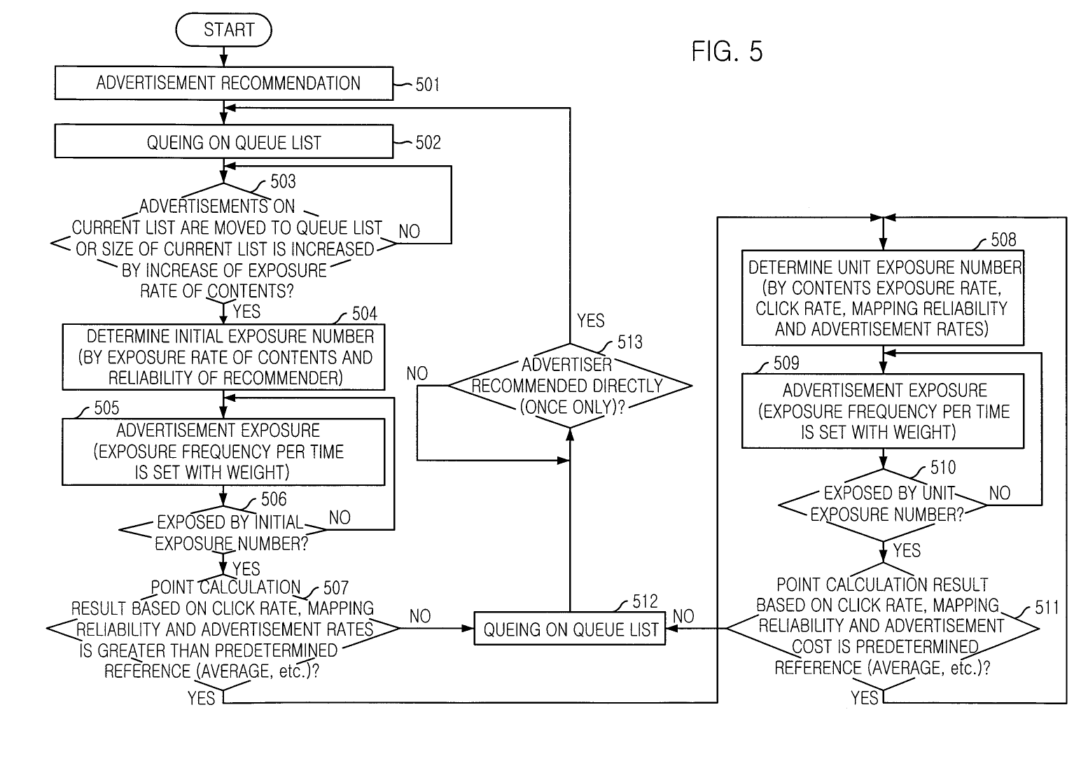

FIG. 5 is a detailed flowchart illustrating an advertising exposure method for improvement of mapping hit-ratio of context advertisement in accordance with another preferred embodiment of the present invention. Particularly, FIG. 5 shows a procedure of determining the exposure frequency of mapped advertisement. Although omitted for convenience of explanation only, the subject of each operation process is the AdHelper site 30.

The HedHelper site 30 manages three advertisement lists per contents 111 as follows: a ‘queue list’, a ‘current list’, and a ‘disuse list’.

First, the ‘current list’ is a list of candidate groups to be exposed in the advertising region 112 of the contents page 11, and an advertising list which is shown when clicking the overall advertising list (see FIG. 3). At this time, the number of candidate groups is determined by the exposure rate of the contents page 11, wherein a page with large exposure has a large number of candidate groups and a page with small exposure has a small number of candidate groups.

Further, the ‘queue list’ is a place where the recommended advertisement stays prior to entering the current list, wherein the advertisement recommended by the recommender is queued in a FIFO manner.

In addition, the ‘disuse list’ is a place to which an advertisement having a point by the click rate, the mapping reliability and the advertising costs less than predetermined references is moved.

Now, the procedure of determining the exposure frequency of mapped advertisement will be described below. First, when an advertisement is recommended by a recommender (501), the recommended advertisement is queued on the queue list (502) and waits for its own sequence.

Next, if the size of the current list is increased by an increased exposure rate of contents (that is, if the size of the current list is increased as taking a large number of candidate groups by an increased exposure of contents, for example, this corresponds to a case of further exposing two advertisements on the current list by an increased exposure rate of contents) or any of advertisements on the current list is got out into the disuse list (that is, if advertisements having a point result calculated by a click rate, mapping reliability, and advertising costs less than a reference value are got into the disuse list among the advertisements on the current list, for example, this corresponds to a case of getting two less than the reference value out of three advertisements on the current list into the disuse list) (503), they are entered into the current list (for example, the two advertisements on the queue list are entered into the current list). At this time, an initial exposure number is determined for the advertisements that have been newly entered (504). Here, the ‘initial exposure number’ is determined by the exposure rate of the contents and the reliability of recommender and the advertisements that have been entered into the current list are verified through exposure by the initial exposure number by consumers (505 and 506). That is, if the exposure rate of contents and the reliability of recommender are high, the initial exposure number becomes large correspondingly thereto, and if the exposure rate of contents and the reliability of recommender are low, the initial exposure number becomes small correspondingly thereto.

Once the advertisements have been exposed by the initial exposure number, it is determined whether they are on the current list or to be got out into the disuse list (507). At this time, the reference value is determined based on the click rate, the mapping reliability and the advertising costs.

If the number of advertisements that have been exposed by the initial exposure number is less than the reference value (507), the corresponding advertisements are queued on the disuse list (512).

But, if the number of advertisements that have been exposed by the initial exposure number is greater than the reference value (507), the corresponding advertisements may stay on the disuse list. From this time, the exposure is determined by a unit exposure number, not the initial exposure number (508), and those advertisements are verified through exposure by the unit exposure number by consumers (509 and 510). At this time, the unit exposure number is determined depending on the exposure rate of contents, the click rate, the mapping reliability, and the advertising costs. In other words, advertisements with high click rate, high mapping reliability and high advertising costs are more exposed by the unit exposure number in a WRR way. Thereafter, the number of advertisements that have been exposed by the unit exposure number is compared with the reference value once more (511), and if the number is greater than the reference value, the unit exposure number is again taken (508) and they are exposed by the unit exposure number (509 and 510), and if the number is less than the reference value, they are queued on the disuse list (512).

At this time, the advertisements that have been entered into the disuse list cannot be exposed again in principle for the corresponding contents, but there may be a chance of reentering into the queue list only once by the advertiser (if recommended directly by the advertiser) in order to prevent ill-intended mapping by a competitive company (513). At this time, it is also possible to move to the very beginning of the queue list.

The advertising exposure method for improvement of mapping hit-ratio of context advertisement (the procedure of determining the exposure frequency of mapped advertisement) as set forth above can be applied in the same manner in the ‘SurfHelper system (context information recommendation service system)’ which offers link information related to the contents. Therefore, a detailed description and drawings therefor will be omitted here. In this case, however, regarding the information being managed in the respective lists (the queue list, the current list and the disuse list), the link information related to the contents, not the recommended advertisement, is managed, and the related link information is exposed together upon exposure of the contents.

In utilization example of the AdHelper service mentioned above, if a recommender's favorable site or field is registered in advance for convenience of people who specially do advertisement recommendation, it may be possible to offer a service of notifying, when new contents of the corresponding field are to be created from the corresponding site, the recommender of this. That is, if the new contents page is created from the contents site, a code related to the AdHelper site 30 is inserted into the contents page and the AdHelper site 30 knows that the new contents were created from the corresponding site by using this code and notifies the recommender who have registered this of the fact. Of course, this service may be offered for all sites or only for unpopular contents sites.

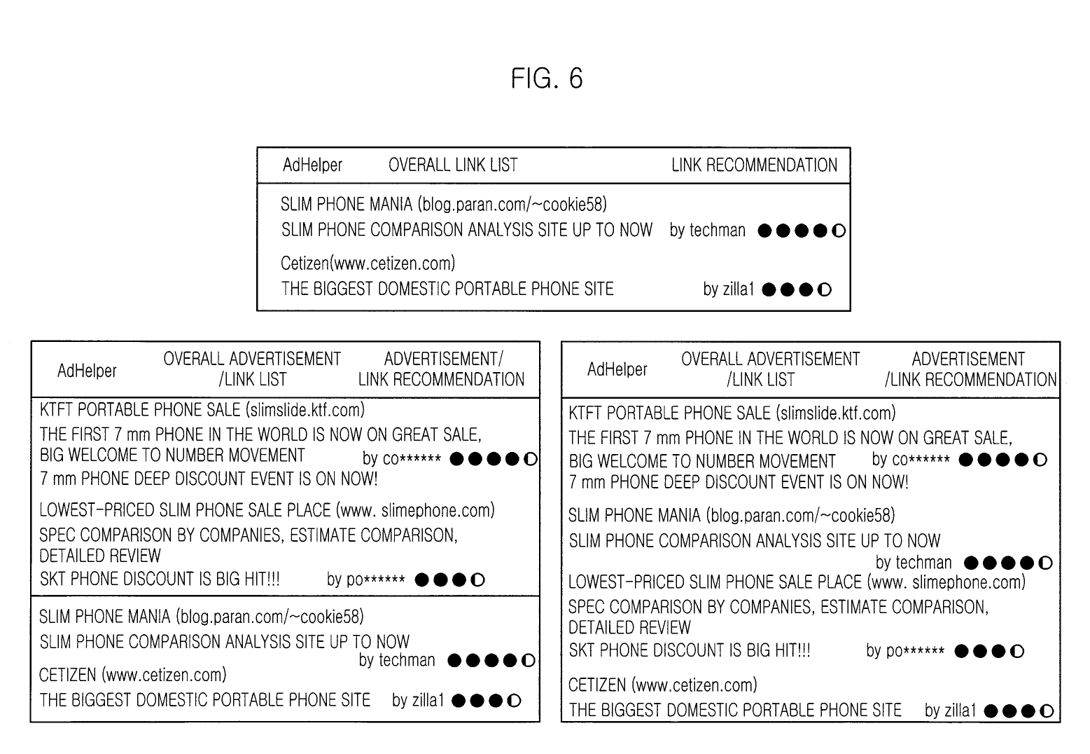

Further, the SurfHelper service may be provided in addition to the AdHelper service. If the AdHelper service is the advertisement 112 related to the contents 111, the SurfHelper service (see FIG. 6) becomes link information related to the contents 111. As one example, it may be frequently seen that the news portal and so on provide related article for one article. Applied the collective intelligence like the AdHelper to this field is the SurfHelper service. The SurfHelper service may be configured in a similar manner to the AdHelper service, but, in case of the SurfHelper service, a monetary compensation is impossible. Therefore, it would be more preferable to induce participation through honorable compensation. In other words, an excellent person is chosen by corresponding keywords by making a keyword (tag) inputted when recommending related link information, which enables honorable compensation.

In the configuration of the ‘SurfHelper system (context information recommendation service system)’ that provides the link information related to the contents as such, although not shown in the drawings, the system includes a link information recommendation part (which corresponds to the advertisement recommendation part 34 of FIG. 1) for allowing a user (recommender) to recommend link information that coincides with the details of contents, a link information list provider (which corresponds to the overall advertising list 33 of FIG. 1) for managing the link information recommended by the user (recommended link information) by contents, and mapping the recommended link information (which is link information by contents selected by the user (recommender) when it is determined to be complied with the details of contents, wherein an exposure number is determined depending on the exposure rate of the contents and exposed in a WRR manner upon exposure of the contents, and contents with large exposure have a large number of candidate groups of link information and contents with small exposure have a small number of candidate groups of link information) by an initial exposure number (which is determined by the exposure rate of the contents and the reliability of recommender) and a unit exposure numbers (which is determined by the exposure rate of the contents, a click rate, and mapping reliability) to expose the same (wherein the reliability of recommender who recommended the link information and the reliability of mapping of the contents and the recommended link information are displayed together upon exposure of the recommended link information, and the reliability of recommender is represented by an accumulation value of the reliability of mapping) upon exposure of the contents, and a mapping evaluation part (which corresponds to the mapping evaluation part 35 of FIG. 1) for supporting that an evaluator can evaluate the mapping result of the exposed contents and the recommended link information.

Further, the SurfHelper service and the AdHelper service can be provided in one contents page 11 separately or together, as shown in FIG. 6. That is, the link information related to the SurfHelper service is provided by being mixed together in the advertising region 112 of the AdHelper service, which can be used to enhance the click rate of the AdHelper service and improve an image. In addition, it is also possible to provide the SurfHelper service only, without providing the AdHelper service.

Specifically, in case the SurfHelper service and the AdHelper service are provided at the same time, when the consumer opens the contents page, the links of the AdHelper service and the SurfHelper service are embedded in the contents page so that related information is received from the AdHelper and SurfHelper sites and displayed on one screen. At this time, since the SurfHelper service is related link information not advertisement, it is expected that the click rate of consumer will be higher. Therefore, there may be a high possibility that the link already visited by the consumer are overlapped and displayed. Thus, when sending the related information from the SurfHelper site, if the number of links to be displayed in the corresponding contents page is 2, about 4-6 that is a multiple of 2-3 is sent and compared with the history of web browser. It would be preferable that the links excepting the links already visited are displayed.

Further, in case the SurfHelper is to be linked with the AdHelper, the reliability of recommender is linked therewith to raise the reliability of recommender who recommends much useful link information through the SurfHelper, thus giving a benefit when recommending an advertisement at the AdHelper.

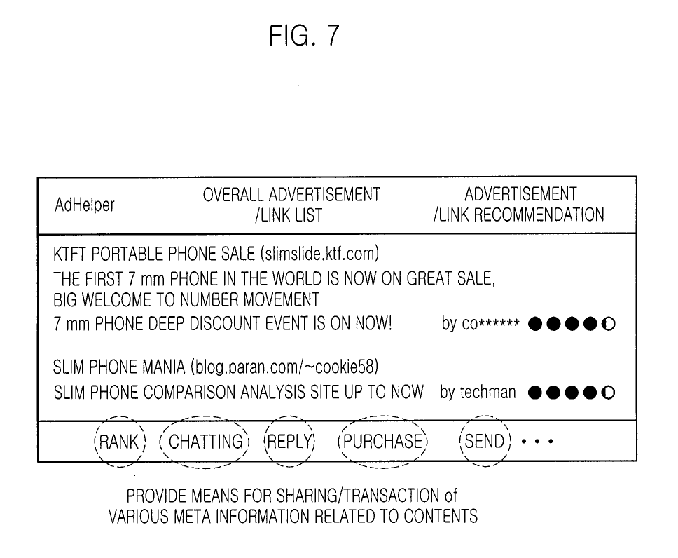

In addition, a MetaHelper service that offers various services related to contents may be provided, in addition to the AdHelper and the SurfHelper. That is, as shown in FIG. 7, the MetaHelper offers a convenient interface that allows the use of various services such as rank, chatting, reply, purchase, send, etc. related to the contents by click only.

The method of the present invention as mentioned above may be implemented by a software program that is stored in a computer-readable storage medium such as CD-ROM, RAM, ROM, floppy disk, hard disk, optical magnetic disk, or the like. This procedure may be readily carried out by those skilled in the art; and therefore, details of thereof are omitted here.

While the present invention has been described with respect to the particular embodiments, it will be apparent to those skilled in the art that various changes and modifications may be made without departing from the spirit and scope of the invention as defined in the following claims.

What is claimed is:

1. An exposure method of Internet information for improvement of mapping hit-ratio of context information, the method comprising the steps of:
queuing information recommended (‘recommended information’) by a user who coincides with details of contents on a queue list;
selecting a candidate group (current list) to be exposed in an information region of contents page out of the recommended information on the queue list;
determining an initial exposure number of each recommended information on the current list, and mapping each recommended information on the current list by the initial exposure number upon exposure of the contents to expose the same;
comparing each recommended information that has been exposed by the exposure number with a reference value to determine whether its remaining on the current list is required; and
determining a unit exposure number of recommended information that remains on the current list (residual recommended information), and mapping the residual recommended information by the unit exposure number upon exposure of the contents, to thereby expose the same.

2. The method of claim 1, further comprising the steps of:
comparing residual recommended information that has been exposed by the unit exposure number with the reference value to determine whether its remaining on the current list is required; and
determining a unit exposure number of residual recommended information that again remains on the current list (re-residual recommended information), and mapping the re-residual recommended information by the unit exposure number upon exposure of the contents, to thereby expose the same.

3. The method of claim 2, further comprising the step of allowing one of recommended information above the reference value, the residual recommended information and the re-residual recommended information to remain on the current list.

4. The method of claim 2, further comprising the step of queuing one of recommended information below the reference value, the residual recommended information and the re-residual recommended information on a disuse list.

5. The method of claim 1, wherein the contents are information provided through a web/wap page.

6. The method of claim 5, wherein the recommended information is any one of context advertisement that is in the form of text, a moving image and character/voice advertisement by contents, which are selected by the user (recommender) when it is determined to be coincided with the details of contents.

7. The method of claim 6, wherein, in case the contents are moving image contents composed of several frames, since moving image advertisements are mapped by frame groups, several moving image advertisements are exposed alternately while the moving image contents are being played.

8. The method of claim 5, wherein the recommended information is link information by contents that is selected by a user (recommender) when it is determined to be coincided with the details of contents.

9. The method of claim 1, wherein the contents are multimedia information provided over TV or radio.

10. The method of claim 9, wherein the recommended information is any one of moving image advertisement and character/voice advertisement by contents, which are selected by a user (recommender) when it is determined to be coincided with the details of contents.

11. The method of claim 10, wherein, in case the contents are moving image contents composed of several frames, since moving image advertisements are mapped by frame groups, several moving image advertisements are exposed alternately while the moving image contents are being played.

12. The method of claim 4, further comprising the step of reentering one of advertisement recommended by an advertiser, the residual recommended advertisement and the re-residual recommended advertisement, among advertisements queued on the disuse list, into the queue list.

13. The method of claim 4, wherein the candidate group (current list) to be exposed to the advertisement region of the contents page is varied in size depending on an exposure rate of the contents, and a page with large exposure has a large number of candidate groups of advertisement and a page with small exposure has a small number of candidate groups of advertisements.

14. The method of claim 13, wherein the initial exposure number is determined by the exposure rate of the contents and the reliability of recommender.

15. The method of claim 14, wherein the unit exposure number is determined by the exposure rate of the contents, a click rate, mapping reliability, and advertising costs.

16. The method of claim 15, wherein the recommended advertisement on the current list, the residual recommended advertisement or the re-residual recommended advertisement is determined in advertisement number depending on the exposure rate of the contents and exposed in a WRR (Weighted Round Robin) way.

17. The method of claim 16, wherein the queue list is a place where the recommended advertisement is queued before entering the current list, and the recommended advertisement is queued in a FIFO (First-In First-Out) manner.

18. The method of claim 17, wherein the current list is candidate groups to be exposed in the advertisement region of the contents page, and the number of the candidate groups is determined by the exposure rate of the contents page.

19. The method of claim 18, wherein the disuse list is a place where advertisements having the click rate, the mapping reliability, or point by the advertising costs less than the reference value among the advertisements on the current list are queued, and the advertisement recommended by the advertiser among the advertisements queued on the disuse list reenters the queue list.

20. A context advertisement recommendation service system for improvement of mapping hit-ratio of context advertisement through linkage between a contents site and an advertiser site, the system comprising:
an advertisement registration means for supporting that advertisements are to be registered;
an advertisement recommendation means for providing an advertisement related to a user input keyword for the user (recommender) to recommend an advertisement that coincides with details of contents;
an advertisement list providing means for managing the advertisement recommended by the user (‘recommended advertisement’) by contents, and mapping the recommended advertisement by an initial exposure number and a unit exposure number upon exposure of the contents to expose the same; and
a mapping evaluation means for supporting that an evaluator can evaluate the mapping result of the exposed contents and the recommended advertisement.

21. The system of claim 20, wherein the contents are information provided through a web/wap page, and the recommended information is any one of context advertisement that is in the form of text, a moving image and character/voice advertisement by contents, which are selected by the user (recommender) when it is determined to be coincided with the details of the contents.

22. The system of claim 21, wherein, in case the contents are moving image contents composed of several frames, since moving image advertisements are mapped by frame groups, several moving image advertisements are exposed alternately while the moving image contents are being played.

23. The system of claim 21, wherein the recommended advertisement is determined in exposure number depending on an exposure rate of the contents and exposed in a WRR way upon exposure of the contents, and contents with large exposure are exposed along with a large number of advertisements and contents with small exposure are exposed along with a small number of advertisements.

24. The system of claim 20, wherein the initial exposure number is determined by the exposure rate of the contents and the reliability of recommender, and
the unit exposure number is determined by the exposure rate of the contents, a click rate, mapping reliability, and advertisement costs.

25. The system of claim 24, wherein the reliability of recommender who recommended the advertisement, the reliability of mapping of the contents and the recommended advertisement are displayed together upon exposure of the recommended advertisement, and the reliability of recommender is represented by an accumulation value of the mapping reliability and the initial value of the mapping reliability is calculated from the reliability of recommender.

26. The system of claim 25, wherein, when a consumer clicks the recommended advertisement, a consumer's ID, an IP address, a click time and a contents address remain in the contents site as log and the log information is sent to the context advertisement recommendation service system (AdHelper site) and the advertiser site, and the consumer's visit, movement and action remain in the advertiser site as log and its pattern is analyzed based on the consumer's ID and IP to check whether the click is a lawful one, to thereby inform the context advertisement recommendation service system (AdHelper site) of the log information and pattern information of the consumer.

27. The system of claim 25, wherein related link information of a context information recommendation service system is provided by adding it to the advertisement region by linking with the context information recommendation service system that offers the link information related to the contents.

28. The system of claim 27, wherein, if the context advertisement recommendation service system is linked with the context information recommendation service system, it gives a benefit when recommending an advertisement therein by enhancing the reliability of recommender who recommended useful link information a lot through the context information recommendation service system.

29. The system of claim 25, wherein, upon creation of new contents, the context advertisement recommendation service system notifies the recommender of that the contents was newly created to recommend an advertisement that coincides with details of the new contents.

30. The system of claim 25, wherein the evaluator's ID is partially disclosed or anonymously disclosed upon output of mapping evaluation result of the exposed contents and the recommended advertisement.

31. The system of claim 25, wherein the advertiser distributes a predetermined amount of money per click, exposure, purchase of consumer, or specific action like joining to a contents owner and/or recommender, upon distribution of profit by exposure of the recommended advertisement.

32. The system of claim 31, wherein the contents owner is a medium such as an Internet community site or UCC, and if a user (contents register) registers the contents in the medium, the medium accepts a distributed amount of money and distributes the same to the contents register.

33. The system of claim 31, wherein, for the amount of money distributed to the recommender, a higher distribution rate is applied if the mapping reliability of advertisement is high and a lower distribution rate if the mapping reliability of advertisement is low, upon distribution of profit by exposure of the recommended advertisement.

34. The system of claim 24, wherein, when the recommender inputs a keyword to search, the advertisement recommendation means sorts an advertisement related to the keyword and displays it to the recommender, the sorting being done based on any one of advertising costs per click, a click number, an exposure number and mapping reliability.

35. The system of claim 34, wherein, if the recommender recommends a specific advertisement among advertisements resulted from the keyword search, further includes a comment input function upon recommendation of advertisement.

36. The system of claim 35, wherein the advertisement recommendation means gives special effects including flickering and flowing for the recommended advertisement and comments inputted by the recommender upon recommendation of advertisement, or improves the degree of notice of advertisement by using an identifier having an icon and a figure text.

37. The system of claim 36, wherein the search keyword is tag information on the corresponding contents or advertisement, which can be utilized as meta data of the contents or advertisement.

38. The system of claim 24, wherein the mapping evaluation means can increase or decrease the mapping reliability within a predetermined range, and increase the mapping reliability by click or exposure of advertisement, in addition to the mapping evaluation.

39. The system of claim 25, wherein the recommended advertisement is provided in link with TV or radio broadcasting network.

40. The system of claim 25, wherein the recommended advertisement is used in a service related to the contents, for example, a MetaHelper service including rank, chatting, reply, purchase, and send.

41. A context information recommendation service system for improvement of mapping hit-ratio of context information, the system comprising:
a link information recommendation means for allowing a user (recommender) to recommend link information that coincides with details of contents;
a link information list providing means for managing the link information recommended by the user (‘recommended link information’) by contents, and mapping the recommended link information by an initial exposure number and a unit exposure number upon exposure of the contents to expose the same; and
a mapping evaluation means for supporting that an evaluator can evaluate the mapping result of the exposed contents and the recommended link information.

42. The system of claim 41, wherein the contents are information provided through a web/wap page, and the recommended link information is link information by contents selected by the user (recommender) when it is determined to be coincided with the details of the contents.

43. The system of claim 42, wherein the recommended link information is determined in exposure number depending on an exposure rate of the contents and exposed in a WRR way upon exposure of the contents, and contents with large exposure have a large number of candidate groups of link information and contents with small exposure have a small number of candidate groups of link information.

44. The system of claim 41, wherein the initial exposure number is determined by the exposure rate of the contents and the reliability of the recommender, and
the unit exposure number is determined by the exposure rate of the contents, a click rate, and mapping reliability.

45. The system of claim 44, wherein the reliability of recommender who recommended the link information, the reliability of mapping of the contents and the recommended link information are displayed together upon exposure of the recommended link information, and the reliability of recommender is represented by an accumulation value of the mapping reliability.

46. The system of claim 44, wherein an evaluator's ID is disclosed upon output of the mapping evaluation result of the exposed contents and the link information.

47. The system of claim 44, wherein the recommended link information to be displayed upon exposure of the contents is sent to the web browser of the user (consumer) larger than the number to be displayed, and is compared with a history in the web browser of the user so that links excepting links previously visited are displayed.

48. A computer-readable recording medium for storing a program implementing a method for improving mapping hit-ratio of context information in an information exposure system with a processor, the method comprising the steps of:
queuing information recommended (‘recommended information’) by a user, which coincides with details of contents, on a queue list;
selecting a candidate group (current list) to be exposed in an information region of contents page out of recommended information on the queue list;
determining an initial exposure number of each recommended information on the current list, and mapping each recommended information on the current list by the initial exposure number upon exposure of the contents to expose the same;
comparing each recommended information that has been exposed by the initial exposure number with a reference value to determine whether its remaining on the current list is required; and
determining a unit exposure number of the recommended information that remains on the current list (residual recommended information), and mapping the residual recommended information by the unit exposure number upon exposure of the contents to thereby expose the same.
